(19) United States
(12) Patent Application Publication
(10) Pub. No.: US 2008/0037009 A1
(43) Pub. Date: Feb. 14, 2008

(54) Spectrometer system with IR microscope and electronically switchable detectors

(75) Inventor: Arno Simon, Karlsruhe (DE)

Correspondence Address: KOHLER SCHMID MOEBUS, RUPPMANNSTRASSE 27, D-70565 STUTTGART, omitted

(73) Assignee: Bruker Optik GmbH, Ettlingen (DE)

(21) Appl. No.: 11/826,744

(22) Filed: Jul. 18, 2007

(30) Foreign Application Priority Data
Aug. 10, 2006 (DE) 10 2006 037 524.6

(51) Int. Cl. G01N 21/00

(52) U.S. Cl. 356/73

(57) ABSTRACT

A spectrometer system (1) comprising an IR (infrared) spectrometer (2) and an IR microscope (3), wherein a sample (42) and a first detector (21; 31) are provided in the IR microscope (3), wherein the IR microscope (3) is designed such that during measurement, the sample (42) is imaged on the first detector (21; 31) via an intermediate focus (44), is characterized in that at least one second detector (24, 25; 33) is provided whose detector surface (26, 27; 34) extends parallel to the detector surface (22; 32) of the first detector (21; 31), the detector surface (26, 27; 34) of the at least one second detector (24, 25; 33) is at least 5 times larger than the detector surface (22; 32) of the first detector (21; 31), and the first (21; 31) and the at least one second detector (24, 25; 33) are disposed directly next to each other, wherein the detector surface (26, 27; 34) of the at least one second detector (24, 25; 33) largely surrounds the detector surface (22; 32) of the first detector (21, 31), and the first detector (21; 31) can be read out independently of the at least one second detector (24, 25; 33). The inventive spectrometer system yields a good signal-to-noise ratio both for large and small selected sample areas.

This application claims Paris Convention priority of DE 10 2006 037 524.6 filed Aug. 10, 2006 the complete disclosure of which is hereby incorporated by reference.

### BACKGROUND OF THE INVENTION

The invention concerns a spectrometer system comprising an IR (infrared) spectrometer and an IR microscope, wherein a sample and a first detector are provided in the IR microscope, and the IR microscope is designed such that the sample is imaged on the first detector via an intermediate focus during measurement.

A spectrometer system of this type is disclosed e.g. by the company leaflet “Hyperion series Microspectroscopy” of the company Bruker Optics Inc., Billerica, Mass., USA, 2005 and the model Hyperion 1000 described therein.

Infrared (IR) spectroscopy is an instrumental analysis method. IR spectroscopy determines oscillation bands of molecules or molecular groups in a sample, thereby identifying the molecules or molecular groups in the sample.

Conventional spectrometer systems gain information about samples, e.g. powder or liquid samples, without spatial resolution. A zero-dimensional IR detector which is used in such a spectrometer system has a detector surface edge length of typically around 1 mm.

Spectrometer systems with IR microscope gain location-specific information about larger samples, e.g. surfaces of thin film samples. A small area of the sample is selected using microscope mechanics (e.g. an xy table) and microscopy optics (e.g. a collimator). Only the IR radiation which interacts with the selected area is evaluated. The spatial variation of the sample is obtained by scanning the sample, i.e. by relative displacement of the selected area on the sample. The zero-dimensional IR detector (or single element detector) of an IR microscope typically has a detector surface edge length of between 50 and 250 μm.

All IR detectors generate noise during operation which aggravates the evaluation of the sample signals. This noise increases the larger the edge length of the IR detector surface.

IR microscopes therefore use relatively small detectors in order to limit the noise. However, the small detector surface can cause only part of the IR radiation of interest from the sample to be registered on the detector, and another part passes the detector, whereby sample information may be lost. This can happen, in particular, when the selected sample area is larger. If, however, a larger IR detector is used, the illumination of the detector surface could be marginal and the noise excessive. This is to be expected, in particular, when the selected sample areas are small.

In contrast thereto, it is the underlying purpose of the present invention to present a spectrometer system of the above-mentioned type, with which a good signal-to-noise ratio can be obtained both for large and for small selected sample areas.

### SUMMARY OF THE INVENTION

This object is achieved by a spectrometer system of the above-mentioned type, which is characterized in that at least one second detector is provided whose detector surface extends parallel to the detector surface of the first detector, the detector surface of the at least one second detector being at least 5 times larger than the detector surface of the first detector, and the first and the at least one second detector are disposed directly next to each other, wherein the detector surface of the at least one second detector largely surrounds the detector surface of the first detector, and the first detector can be read-out independently of the at least one second detector.

The optimum detector for the selected sample area can be used with the inventive spectrometer system. The first detector can be used for the investigation of a comparably small sample area and be read-out separately. Due to its smaller size, it generates less noise than the at least one second detector. Separate reading-out thereof prevents noise input from the second detectors (one pixel of an FPA detector thereby cannot be read-out separately or independently of the other pixels). The first detector can thereby be properly illuminated which would not be possible with the larger, at least one second detector. In order to investigate a comparably large sample area, the at least one second detector can be used alone or (preferably) also together with the first detector. The IR radiation from the sample which misses the first detector is registered by the at least one second detector surrounding it, and can therefore be evaluated. No information is thereby lost. The at least one second detector is then also properly illuminated to also obtain a good signal-to-noise ratio.

Switching over between the detectors may be easily effected electronically, i.e. through selection of the detector or detectors which are read out. Alternatively, both detectors may also be read out simultaneously (but independently of each other) and the sample area to be analyzed may be selected digitally.

It is noted that in accordance with the invention, when there are several second detectors, “at least one second detector” means all second detectors, in particular with respect to the area ratio between first detector and all second detectors, and also with respect to the first detector being surrounded by all second detectors. When there are several second detectors, the totality of the second detectors is read out in common such that the detector surfaces of all second detectors form an overall detector surface from which integral information is obtained.

The first detector is surrounded by the at least one second detector at least partially in the direction of extension of the detector surfaces, in particular on three or all four sides of the detector surface of the first detector.

The first detector and the second detector or the second detectors are each formed as zero-dimensional detectors without spatial resolution. Zero-dimensional detectors (single element detectors) produce a very good signal-to-noise ratio (=SNR) which is superior, in particular, to the SNR of FPA detectors (FPA=focal plane array). PFA detectors are not used within the scope of the invention.

The first and the at least one second detector may be of different detector types, in particular with regard to the detector material. This permits adjustment to the respective detection task, e.g. in view of sensitivity.

In one particularly preferred embodiment, the detector surface of the at least one second detector is at least 10 times, in particular at least 25 times larger than the detector surface of the first detector. This surface ratio yields an even better improvement of the SNR by switching over the detectors.

In one further advantageous embodiment, the first and the at least one second detector are disposed in a common refrigerator housing, in particular, with cooling being effected with liquid nitrogen. The first and the at least one second detector can thereby be cooled by only one cooling means of simple construction and at little cost.

In one further preferred embodiment, the first detector and/or the at least one second detector is/are a HgCdTe detector. HgCdTe detectors have proven to be useful in practice.

In another preferred embodiment of the inventive spectrometer system, the IR microscope is designed for reflection operation and/or transmission operation and/or ATR (attenuated total reflection) operation. These operating modes can measure all important sample types.

In one particularly preferred embodiment, the IR spectrometer is designed as a FTIR (Fourier transformation infrared) spectrometer. FTIR spectrometers have proven to be useful in practice.

In one advantageous embodiment, the first detector is disposed in a recess of the detector surface of the at least one second detector. This prevents overlapping of the detectors and permits arrangement of the detector surfaces of the first and second detectors in the same plane.

In another advantageous embodiment, the first detector is disposed between two second detectors, with the result that the second detectors have a simple construction and largely surround the first detector.

In a preferred further development of this embodiment, the two second detectors are substantially C-shaped and face each other. The first detector may be arranged in the center of the two Cs, and is then surrounded on all sides by the second detectors. Alternatively, a C-shaped second detector and a rectangular second detector may also be used to the same advantage.

In an advantageous embodiment, the first detector is disposed on the detector surface of the second detector. This is particularly simple to realize and permits any orientation of the detector surfaces, in particular, that the detector surface of the first detector is completely surrounded. The detector types may differ.

In one particularly preferred embodiment, a collimator is disposed in the intermediate focus. The collimator permits selection of the area of the sample to be imaged on the detector in a simple fashion. The rest of the sample is shadowed. There is also sufficient space for the collimator on the intermediate focus, such that simple construction and good handling is ensured. Neither the sample nor the detector impair the collimator arrangement.

In an advantageous further development of this embodiment, the collimator is designed as a variable collimator with variable collimator diameter, whereby the size of the selected sample area can be varied. The variable collimator can preferably be realized by an iris or a slit collimator. This permits quasi continuous collimator diameters. Exchangeable collimators may alternatively be provided, e.g. on a collimator revolver.

The first detector is preferably completely surrounded by at least one second detector. The first detector is preferably also centered relative to the second detector (i.e. the first detector surface is at the center of the second detector surface). When the detectors are switched over, only the extent of the surroundings of a sample point from which information is obtained is changed and not the relative position of the sample point on the sample. This facilitates orientation on the sample.

In another preferred fashion, the IR microscope comprises an optical system which permits enlarged, light-optical observation of the sample, in particular of the sample area selected for IR spectroscopy, in the visible spectral range.

In accordance with the invention, the at least one second detector may be surrounded by at least one third detector, whose detector surface also extends parallel to the detector surface of the first detector. The at least one third detector may, in turn, be surrounded by at least one further detector and so forth. This enables fine adjustment to the illumination of the detectors during evaluation of the detectors in order to optimize the SNR. Annular detector elements which are disposed concentrically about the central first detector may be used for such an arrangement. The annular detector elements may be read-out separately.

Further advantages of the invention can be extracted from the description and the drawing. The features mentioned above and below may be used in accordance with the invention either individually or collectively in arbitrary combination. The embodiments shown and described are not to be understood as an exhaustive enumeration but have exemplary character for describing the invention.

The invention is shown in the drawing and explained in more detail with reference to embodiments

### BRIEF DESCRIPTION OF THE DRAWING

FIG. 1 shows a schematic perspective view of an inventive spectrometer system with IR spectrometer and IR microscope;

FIG. 2 shows a schematic top view of a detecting arrangement with a central detector surface of a first detector and two second detectors each having a C-shaped detector surface, for an inventive spectrometer system;

FIG. 3 shows a schematic top view of a further detecting arrangement with a central detector surface of a first detector which is disposed on the detector surface of a second detector, for an inventive spectrometer system;

FIG. 4 shows a schematic view of the path of rays in an IR microscope for an inventive spectrometer system.

### DESCRIPTION OF THE PREFERRED EMBODIMENT

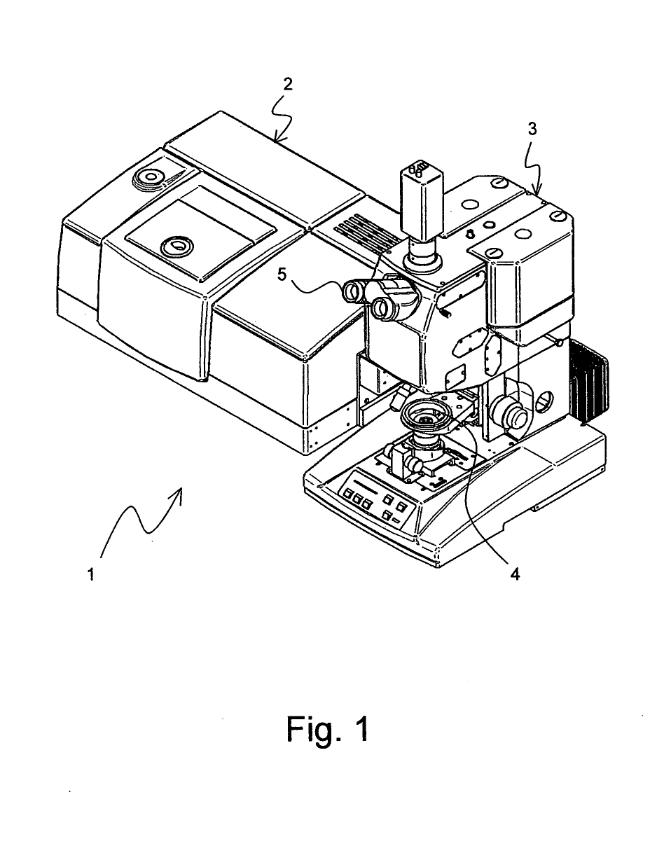

FIG. 1 shows a schematic perspective view of an inventive spectrometer system 1 from the outside.

The spectrometer system 1 comprises an infrared spectrometer 2 which houses an infrared source (not shown) and an interferometer (not shown).

An IR microscope 3 is directly connected to the IR spectrometer 2, such that an IR light beam of the infrared spectrometer 2 can be guided into the IR microscope 3 and used therein.

The IR microscope 3 has a sample plate 4 which can be horizontally displaced in the x and y directions and also vertically in the z direction, either manually or by electromotive control. A sample to be investigated may be disposed on the sample plate 4.

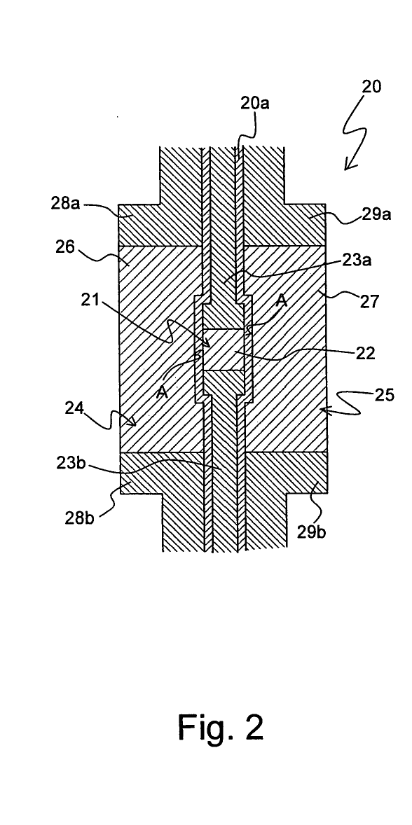

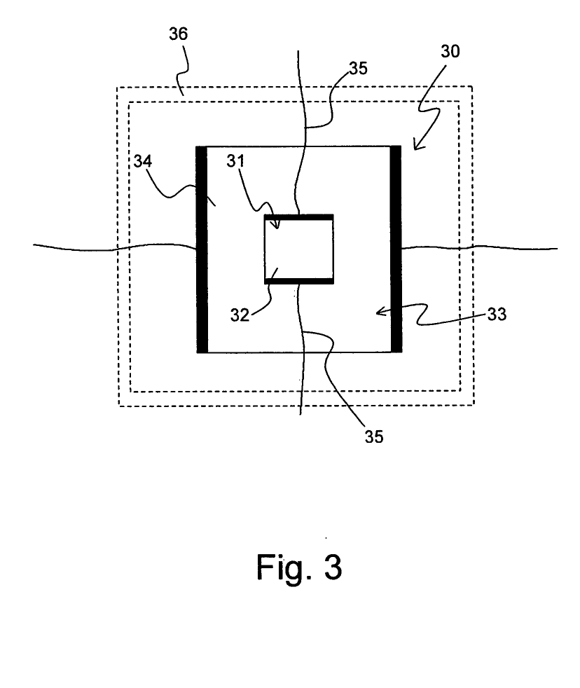

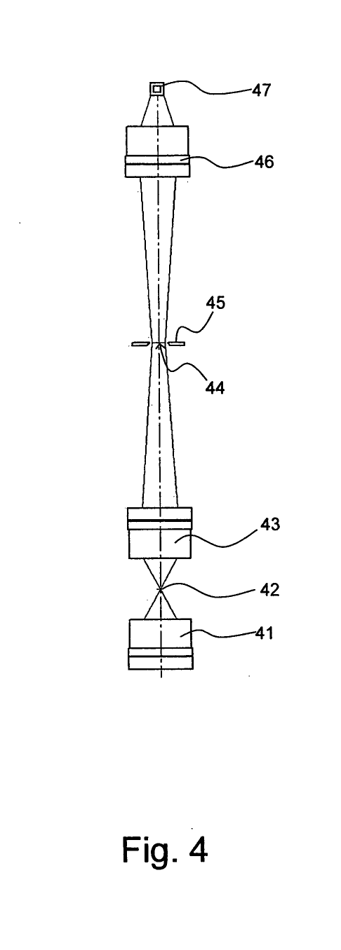

A detection arrangement comprising a first IR detector and at least one second IR detector is provided in the IR microscope 3 (explained in FIGS. 2 and 3). The path of rays of the IR light beam in the IR microscope 3 is explained in more detail in FIG. 4.

The IR microscope 3 also comprises a light-optical system for visible light. An enlarged sample can also be observed with the human eye via double ocular 5. An optical component, in particular a collimator or scale template is thereby preferably provided in a light-optical intermediate focus, which light-optically marks the sample area which is selected for IR spectroscopy. The sample may also be observed beyond the selected sample area using the scale template (e.g. a glass plate with lines).

FIG. 2 shows a schematic top view of a detecting arrangement 20 for an IR microscope for the invention.

The detecting arrangement 20 comprises a first IR detector 21 which has an approximately square, flat detector surface 22. Metallic contacts 23a, 23b are provided on the upper and lower edges of the detector surface 22, via which the detector 21 can be read out.

The detecting arrangement 20 moreover comprises two second detectors 24, 25, each having flat C-shaped detector surfaces 26, 27. The arms of the Cs face each other, thereby encompassing an inner space. The detector surface 22 of the first detector 21 is disposed in this inner space. The detector surfaces 26, 27 of the second detectors 24, 25 may also be regarded as rectangular, each comprising one recess A that faces the center of the detecting arrangement 20, wherein the detector surface 22 of the first detector 21 is disposed in the space defined by the recesses A. The upper and lower edges of each detector surface 26, 27 of the second detectors 24, 25 are connected to metallic contacts 28a, 28b, 29a, 29b, via which the second detectors 24, 25 can be read out.

The detectors 21, 24, 25 are disposed on a carrier 20a. The detector surfaces 22, 26, 27 are at the same level in the z direction (perpendicular to the plane of the drawing).

In the illustrated case, the detector surface 22 of the first detector 21 is approximately 1/25 of the overall detector surface of the two second detectors 24, 25. When the sample area which is imaged on the detector arrangement 20 substantially only illuminates the detector surface 22 of the first detector 21, only the first detector 21 is read out and evaluated in accordance with the invention, thereby obtaining a good SNR. If, however, a larger sample area is imaged which also illuminates the detector surfaces 26, 27 of the second detectors 24, 25, the first detector 21 and the second detectors 24, 25 can be read out and the detected signals can be integrally evaluated. Only very little information is lost, namely in correspondence with the portion of the sample image (or selected sample area) which passes the detectors 21, 24, 25 and e.g. impinges directly on the carrier 20a in the intermediate space between the detectors 21, 24, 25.

A typical edge length of the first detector surface 21 is 20 μm to 200 μm and typical outer dimensions of the overall detector surface of the second detectors 24, 25, are 100μ to 1000 μm.

FIG. 3 shows another inventive design of a detecting arrangement 30 comprising a first detector 31 and a second detector 33.

The first detector 31 is disposed on the upper side of the detector surface 34 of the second detector 33, i.e. glued, thereby shadowing a small part of the detector surface 34 of the second detector 33. The remaining free part of the detector surface 34 of the second detector 33 is approximately 8 times larger than the detector surface 32 of the first detector 31.

The first detector 31 is contacted by thin wires 35 to minimize shadowing of the second detector 33 by the contacts of the first detector 31.

The first detector 31 and the second detector 33 are both formed as HgCdTe detectors and disposed in a common refrigerator housing 36, which may be cooled e.g. using liquid nitrogen. Alternatively, other materials may also be used as detector (e.g. InSb) or the type or material of the first detector 31 may differ from that of the second detector 33.

FIG. 4 schematically shows the IR path of rays in an IR microscope in accordance with the invention in transmission operation.

IR radiation (not shown) that is incident on a capacitor 41 is focussed onto a sample 42. The sample 42 may be displaced perpendicularly to the path of rays in x and y direction in order to bring a certain location on the sample 42 into the center of the path of rays.

The sample 42 is imaged on an intermediate focus 44 using an objective 43 (or another suitable optical component). A variable collimator 45 is disposed on the intermediate focus 44 for shadowing a part of the sample 42 which is not of interest, thereby selecting a sample area of interest. The size of the selected sample area can be varied by the variable collimator diameter of the variable collimator 45. Variation of the collimator diameter would appear as a change in separation between the two side parts of the variable collimator 45 (shown in cross-section).

When the variable collimator 45 is suitably designed, the geometry of the selected sample area can also be varied.

The intermediate focus 44 and thereby also the variable collimator 45 and the sample 42 (or the selected sample area of the sample 42) are imaged on a detecting arrangement 47 using an objective 46 (or another suitable optical component). In accordance with the invention, the detecting arrangement 47 comprises one first detector and at least one second detector with electronic switching therebetween. The path of rays need not be changed thereby. The mutually surrounding approximately coplanar arrangement of the detectors requires, in particular, no mechanical switching over between the detectors.

In summary, the invention proposes the use of a first and at least one second detector in substantially the same plane (detection plane) in a spectrometer system with IR microscope, wherein two second detectors together have a considerably larger detector surface than the first detector and the totality of the second detectors with its detector surface surrounds the detector surface of the first detector. Depending on the size of the sample area to be imaged, a detector or a combination of detectors having the best SNR may be used.

I claim:

1. A spectrometer system for examining a sample, the system comprising:
an IR (infrared) spectrometer;
an IR microscope within which the sample is disposed;
a first detector disposed in said IR microscope, said IR microscope being designed such that, during measurement, the sample is imaged on said first detector via an intermediate focus;
at least one second detector having a detector surface which extends parallel to a detector surface of said first detector, said detector surface of said at least one second detector being at least 5 times larger than said detector surface of said first detector, said first and said at least one second detector being disposed directly next to each other, wherein said detector surface of said at least one second detector largely surrounds said detector surface of said first detector; and
means for reading out said first detector independently of said at least one second detector.

2. The spectrometer system of claim 1, wherein said detector surface of said at least one second detector is at least 10 times or at least 25 times larger than said detector surface of said first detector.

3. The spectrometer system of claim 1, wherein said first and said at least one second detector are disposed in a common refrigerator housing.

4. The spectrometer system of claim 3, wherein said housing is cooled using liquid nitrogen.

5. The spectrometer system of claim 1, wherein said first detector and/or said at least one second detector is/are a HgCdTe detector.

6. The spectrometer system of claim 1, wherein said IR microscope is designed for reflection operation, transmission operation, and/or for ATR (weakened total reflection) operation.

7. The spectrometer system of claim 1, wherein said IR spectrometer is designed as an FTIR (Fourier transformation infrared) spectrometer.

8. The spectrometer system of claim 1, wherein said first detector is disposed in a recess of said detector surface of said at least one second detector.

9. The spectrometer system of claim 1, wherein said first detector is disposed between two second detectors.

10. The spectrometer system of claim 9, wherein said two second detectors are substantially C-shaped and face each other.

11. The spectrometer system of claim 1, wherein said first detector is disposed on said detector surface of said second detector.

12. The spectrometer system of claim 1, wherein a collimator is disposed at said intermediate focus.

13. The spectrometer system of claim 12, wherein said collimator is designed as a variable collimator having a variable collimator diameter.
